(19) United States
(12) Patent Application Publication
(10) Pub. No.: US 2022/0374516 A1
(43) Pub. Date: Nov. 24, 2022

(54) REAL TIME THREAT KNOWLEDGE GRAPH

(71) Applicant: Stairwell, Inc., Santa Clara, CA (US)

(72) Inventor: Michael Joseph Wiacek, Santa Clara, CA (US)

(21) Appl. No.: 17/749,083

(22) Filed: May 19, 2022

Related U.S. Application Data
(60) Provisional application No. 63/191,254, filed on May 20, 2021.

(51) Int. Cl. G06F 21/56

(52) U.S. Cl. CPC G06F 21/562; G06F 2221/033

(57) ABSTRACT

Methods, systems, and storage media for identifying malicious software files are disclosed. Exemplary implementations may: obtain a single copy of each file of a plurality of files that is present on one or more of a plurality of computing devices comprising a computing enterprise; store the single copy of each file of the plurality of files in a data store; identify at least one suspicious file in the plurality of files stored in the data store; perform additional analysis of the at least one suspicious file; and identify the at least one suspicious file as a malicious software file based upon the additional analysis.

### CROSS-REFERENCE TO RELATED APPLICATIONS

This present application claims the benefit of priority under 35 U.S.C. § 119(e) to U.S. Provisional Patent Application No. 63/191,254, filed May 20, 2021, the disclosure of which is hereby incorporated by reference in its entirety for all purposes.

### TECHNICAL FIELD

The present disclosure generally relates to Internet security. More particularly, the present disclosure relates to generating a knowledge graph in real time and utilizing such graph to identify software files of interest, e.g., malicious software files.

### BACKGROUND

Internet security is a branch of computer security specifically related to not only the Internet, often involving browser security and the World Wide Web, but also network security as it applies to other applications or operating systems as a whole. A security hacker is someone who explores methods for breaching defenses and exploiting weaknesses in a computer system or network. The Internet security industry generally accepts defeat from security hackers as inevitable. This is fundamentally because if a security hacker is aware of the security program or programs that a target computing device or computing enterprise utilizes to protect themselves from security hacks, the security hacker can obtain a copy of that computer security product, test their malicious software file(s) against it until the security product does not detect it, and then utilize the malicious software file(s) that the security hacker now knows will not be identified by the security program to attack one or more computing devices, for instance, in a computing enterprise. Accordingly, the more the security hacker knows about how a security product operates, the less successful that security product will be at identifying malicious software. As such, the Internet security industry strives to be as opaque as possible, for instance, to the point where the mechanisms with which malicious software is identified are not predictable. When a detection mechanism is kind of a black box, a defender is afforded a lot more opportunity than if a security hacker knows how to evade the detection mechanisms.

### BRIEF SUMMARY

The subject disclosure provides for systems and methods for generating a real-time knowledge graph (e.g., a threat knowledge graph) and utilizing the real-time knowledge graph to identify software files of interest, e.g., malicious software files.

One aspect of the present disclosure relates to a computer-implemented method for identifying malicious software files. The method may include obtaining a single copy of each file of a plurality of files that is present on one or more of a plurality of computing devices comprising a computing enterprise. The method may include storing the single copy of each file of the plurality of files in a data store. The method may include identifying at least one suspicious file in the plurality of files stored in the data store. The method may include performing additional analysis of the at least one suspicious file. The method may include identifying the at least one suspicious file as a malicious software file based upon the additional analysis.

Another aspect of the present disclosure relates to a system configured for identifying malicious software files. The system may include one or more hardware processors configured by machine-readable instructions. The processor(s) may be configured to obtain a single copy of each file of a plurality of files that is present on one or more of a plurality of computing devices comprising a computing enterprise. The processor(s) may be configured to store the single copy of each file of the plurality of files in a data store. The processor(s) may be configured to identify at least one file-of-interest in the plurality of files stored in the data store. The processor(s) may be configured to perform additional analysis of the at least one file-of-interest. The processor(s) may be configured to identify the at least one file-of-interest as a malicious software file based upon the additional analysis.

Yet another aspect of the present disclosure relates to a non-transient computer-readable storage medium having instructions embodied thereon, the instructions being executable by one or more processors to perform a method for identifying malicious software files. The method may include obtaining a single copy of each file of a plurality of files that is present on one or more of a plurality of computing devices comprising a computing enterprise. The method may include storing the single copy of each file of the plurality of files in a data store. The method may include identifying at least one suspicious file in the plurality of files stored in the data store. The method may include performing additional analysis of the at least one suspicious file. The method may include identifying the at least one suspicious file as a malicious software file based upon the additional analysis.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a schematic diagram representing a computing device having a plurality of files associated therewith, according to certain aspects of the present disclosure.

FIG. 2 is a schematic diagram representing a computing enterprise having a plurality of computing devices, each of the plurality of computing devices having substantially the same plurality of files associated therewith, according to certain aspects of the present disclosure.

FIG. 3 is a schematic diagram representing a collection of three computing devices, each of which is part of the same computing enterprise, according to certain aspects of the present disclosure.

FIG. 4 is a schematic diagram representing a collection of files that is present on the three computing devices illustrated in FIG. 3, each file of the collection being present only one time, according to certain aspects of the present disclosure.

FIG. 5 is a schematic diagram representing that five files of the collection of files illustrated in FIG. 4 match one of YARA rule #212A or YARA rule #212B, and that one file is statistically rare, according to certain aspects of the present disclosure.

FIG. 6 is a schematic diagram representing behaviors exhibited by two of the six files identified in FIG. 5, according to certain aspects of the present disclosure.

FIG. 7 is a schematic diagram representing connections established based on behaviors shown in FIG. 6 that are shared with other files, according to certain aspects of the present disclosure.

FIG. 8 is a schematic diagram representing the expansion of connections based upon third party data, according to certain aspects of the present disclosure.

FIG. 9 is a schematic diagram representing the introduction of a new file to the real-time threat knowledge graph, according to certain aspects of the present disclosure.

FIG. 10 is a schematic diagram representing connections to the new file using the real-time threat knowledge graph that permit the new file of FIG. 9 to be identified as malicious, according to certain aspects of the present disclosure.

FIG. 11 illustrates a system configured for identifying malicious software files, in accordance with one or more implementations of the present disclosure.

FIG. 12 illustrates an example flow diagram for identifying malicious software files, in accordance with one or more implementations of the present disclosure.

FIG. 13 is a block diagram illustrating an exemplary computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art that the embodiments of the present disclosure may be practiced without some of these specific details. In other instances, well-known structures and techniques have not been shown in detail so as not to obscure the disclosure.

The subject disclosure provides for systems and methods for generating a real time knowledge graph (e.g., threat knowledge graph) and utilizing such graph to identify software files of interest (e.g., malicious software files). As previously stated, the Internet security industry generally accepts defeat from security hackers as inevitable, fundamentally because if a security hacker is aware of the security program or programs that a target computing device or computing enterprise utilizes to protect themselves from security hacks, the security hacker can obtain a copy of that computer security product, test their malicious software file(s) against it until the security product does not detect it, and then utilize the malicious software file(s) that the security hacker now knows will not be identified by the security program to attack one or more computing devices, for instance, in a computing enterprise. Implementations described herein address these and other problems by providing a platform that may be utilized as a basis for cyber-situational awareness.

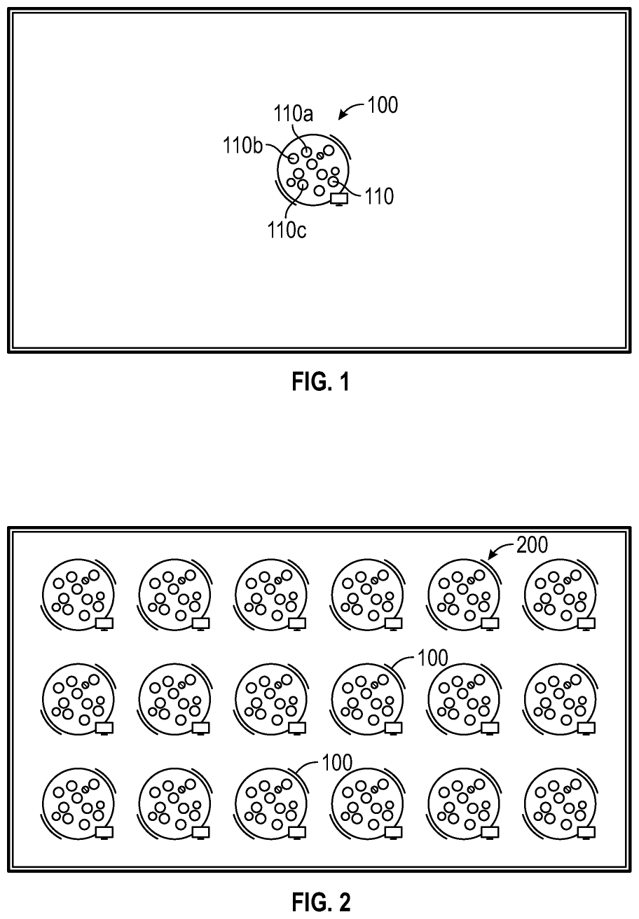

FIG. 1 is a schematic diagram representing a computing device 100 having a plurality of files 110 associated therewith, in accordance with certain aspects of the present disclosure. As illustrated, each circular dot 110 represents an executable file associated with (e.g., stored on) the computing device. (For purposes of assuaging privacy concerns, the files will be referred to herein as executable files. It will, however, be understood by those of skill in the art that the computing device files 110 may in actuality be any type of file, executable or non-executable. Embodiments of the present disclosure are not meant to be limited to executable files, even when such terminology is utilized, unless specifically stated to be so limited.) By way of example only, file 110a may be “calculator.exe,” file 110b may be “photoshop.exe,” file 110c may be “solitaire.exe,” etc. That is, each file 110 may be any executable file associated with the computing device 100.

FIG. 2 is a schematic diagram representing a plurality of computing devices 100 collectively forming a computing enterprise 200, according to certain aspects of the present disclosure. A computing enterprise 200, as the term is utilized herein, refers to a plurality of computing devices 100 that each includes substantially the same plurality of files associated therewith. When “substantially” the same plurality of files is referred to herein, those of skill in the art will understand this to mean that a large majority of the plurality of files on each computing device 100 is the same. While a computing device 100 in a computing enterprise 200 may include a small number of files (e.g., less than 10% of the files associated with the computing device or less than 5% of the files associated with the computing device) that are not the same as the other computing devices 100 in the enterprise 200, such computing device 100 may still be considered to include “substantially” the same plurality of files, in accordance with certain aspects of the present disclosure.

Imagine that a security hacker is aware that a Target Enterprise utilizes Security Product A to identify malicious software files. Further imagine that the security hacker has configured its malicious software file, Malware X, such that it is not identified by Security Product A. The security hacker then introduces Malware X onto one or more of the computing devices 100 comprising the Target Enterprise 200, knowing it will not be identified by the Target Enterprise's security product. The question then becomes how to identify Malware X so that it can be blocked from the computing devices 100 comprising the Target Enterprise 200.

When a security hacker introduces a malicious software file (e.g., a malware file) onto one (or more) computing devices 100 comprising an enterprise 200, viewing the enterprise computing devices 100 as having substantially the same plurality of files makes for an interesting perspective that may allow the malicious software, Malware X in this scenario, to be identified, as more fully described below.

In accordance with embodiments of the present disclosure, initially a single copy of each and every file on any of the computing devices 100 comprising a computing enterprise 200 is obtained. That is, if there are 18 computing devices 100 comprising a computing enterprise 200 (as shown in FIG. 2), and each file contains executable file ABC.exe, only a single copy of ABC.exe is obtained, rather than 18. Once a single copy of every file that is present on any of the computing devices 100 comprising the computing enterprise 200 is obtained, the file copies are backhauled into a storage system (e.g., a cloud-based data store). In the event that a malicious software file had been introduced on one or more of the computing devices 100 comprising the computing enterprise 200, a copy of the malicious software file also will be backhauled into the storage system.

Once a single copy of every file that is present on any of the computing devices 100 comprising the computing enterprise 200 has been backhauled into the storage system, any malicious software files are identified. Identifying the malicious software file(s) may be accomplished in a number of different ways. For instance, the malicious software file(s) may be identified by heuristics. By way of example only, heuristics may be applied to the stored files to determine that a certain file, rather than being present on each computing device 100 comprising the computing enterprise 200, is present on only a small percentage of the computing devices 100 comprising the computing enterprise 200. For instance, in the computing enterprise 200 illustrated in FIG. 2, a certain file may be present on only 3 of the 18 computing devices 100 comprising the computing enterprise 200. One-sixth of the computing devices may be a low enough percentage to be considered statistically “rare” or unexpected in certain embodiments. (It will be understood and appreciated by those having ordinary skill in the art that the threshold percentage at or under which a file is considered statistically “rare” or unexpected is configurable and may be any desired threshold. Embodiments of the present disclosure are not intended to be limited to any particular percentage, percentage range, or number.) In some embodiments, presence at or below a predetermined threshold percentage (or number) of computing devices may be supplemented with a determination of whether and/or how often the certain file has been identified on other computing devices associated with a customer or public data source. In such embodiments, files that have not previously been identified, or only rarely identified, may be identified a “not widely known” and may be treated with enhanced suspicion. In this way, potentially offending (e.g., suspicious) files may be identified without having to know in advance if they are malicious or not malicious and before such files, if malicious, are propagated to a larger percentage (or number) of computing devices comprising the computing enterprise.

Another method in which a malicious software file may be identified is through the use of YARA rules. YARA is an open-source computing language that provides a way of identifying malware (or other files) by creating rules that look for certain characteristics. Utilizing YARA, a user basically writes a sort of recipe or rule and evaluates suspicious files (or any files) against it to determine if the file matches the rule. Files matching rules then may be considered malicious (or at least suspicious). YARA is widely utilized to scan a directory of files on a single computing device but is not capable of scanning all the computing devices comprising a computing enterprise unless a rule is simply run against each individual computing device file directory. In accordance with certain embodiments of the present disclosure, however, since a single copy of each file present in association with any computing device comprising the computing enterprise has been backhauled to a storage system, a YARA rule may be applied to the storage system to identify potentially malicious files. Applying YARA rules in this way significantly decreases the time, power and resources that would be required to apply the YARA rule against every computing device comprising a computing enterprise individually. Such application not only is more efficient in terms of throughput, but it also reduces the load on individual computing devices that can affect performance of the computing device while the rule is being applied.

In accordance with embodiments of the present disclosure, an index of which files are present on which computing devices comprising a computing enterprise may be created. The index then may be used to identify how common files are among the computing devices comprising the computing enterprise, which files are rare, and which files are not expected to be at locations where they are located. Such an index may be utilized to supplement file examination and the identification of malicious and/or suspicious software files.

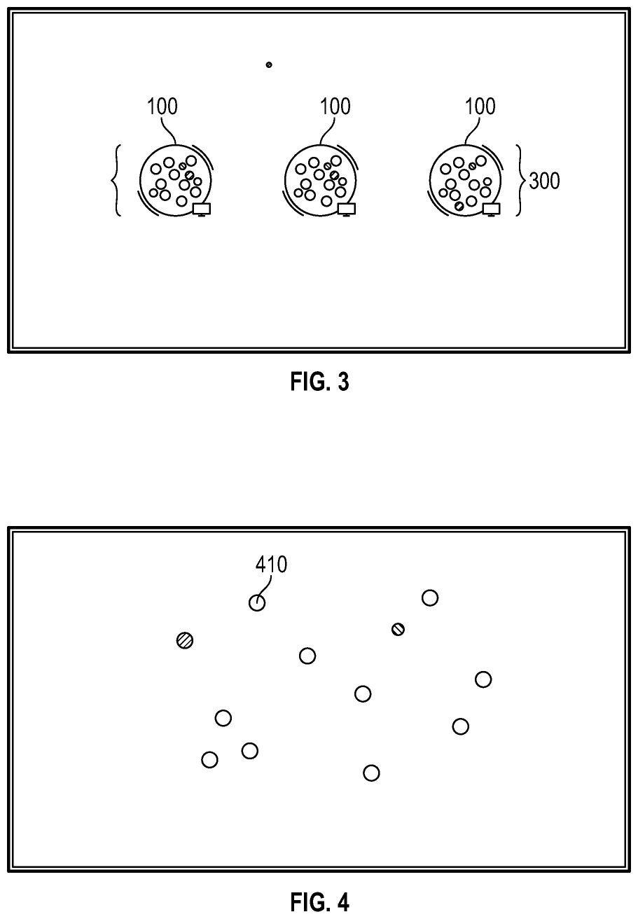

Turning now to FIG. 3, illustrated is a schematic diagram representing a collection of three computing devices 100, each of which is part of the same computing enterprise 300, according to certain aspects of the present disclosure. In accordance with embodiments of the present disclosure, one copy of each file present on any of the computing devices 100 in the computing enterprise 300 is extracted and backhauled to a storage system, as previously described. FIG. 4 is a schematic diagram representing such a collection of files that is present on the three computing devices illustrated in FIG. 3, each file of the collection being present only one time, according to certain aspects of the present disclosure. File 410 may be identified as an anomalous file. It is unknown at the time of identification whether the file 410 is malicious or not malicious but it may be known that the file 410 is present on only, e.g., one computing device 100 in the computing enterprise 300 and has not previously been identified anywhere else (e.g., on computing devices associated with public data sources). Thus, such file 410 may be identified as suspicious and subsequently subjected to additional investigation. Such additional investigation may include, by way of example only, comparing the file 410 to one or more YARA rules.

One challenge often faced in the Internet security industry is that users are often unaware that they have been hacked at some time in the past. A malicious software file may have been present, e.g., extracted sensitive information, and then been removed from the computing device without a user of the computing device and/or operator of the computing enterprise ever being aware of it. In accordance with certain aspects of the present disclosure, as new information is received (e.g., new YARA rules are put into the platform of certain aspects of the present disclosure), the system may scan not only the files that are currently present on one or more computing devices comprising the computing enterprise but all files that have ever been on a computing device comprising the computing enterprise. In this way, security breaches may be identified even after they are no longer a present threat. In this sense, the system of embodiments of the present disclosure may create ongoing operational integrity.

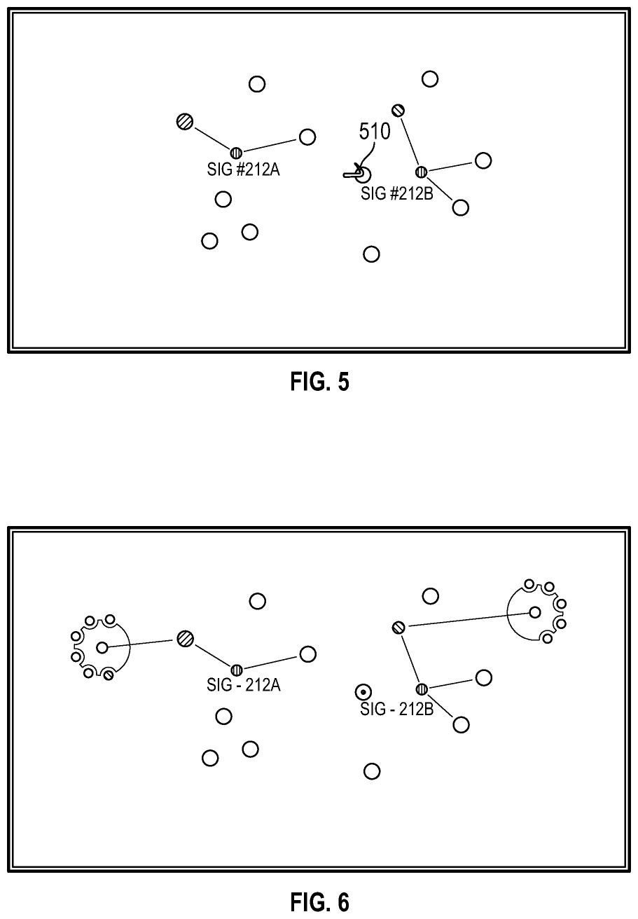

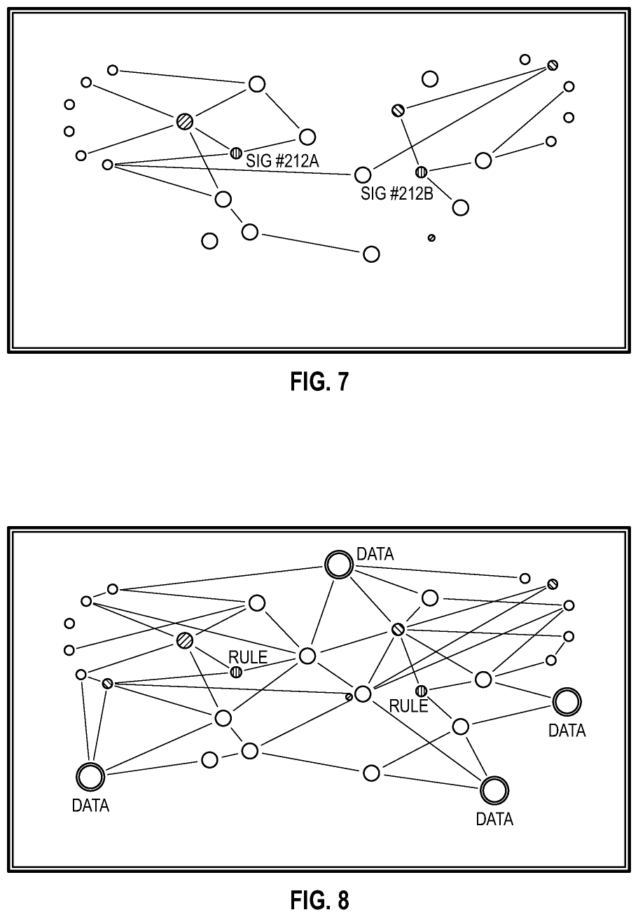

Turning now to FIG. 5, imagine that a user of the system of certain embodiments of the present disclosure introduces one or more YARA rules into the system. Imagine further that five files present within a computing enterprise (e.g., the computing enterprise 200 of FIG. 2) are identified as matching one of YARA rule #212A and YARA rule #212B, and no rules have been identified that match one file 510 and, accordingly, it has been identified as statistically rare. In accordance with certain aspects of the present disclosure, the system may spend additional resources to further investigate the six files. For instance, the six files may be run on a virtual machine that is instrumented such that certain potentially suspicious behaviors may be observed (commonly referred to as “sandboxing”). A potential result of such investigation is illustrated in FIG. 6 (for two of the six files). Potentially suspicious behaviors may include, by way of example only, a file placing a copy of itself in the virtual computing devices temporary directory, a file may connect to EVIL.com (or another web address known to be associated with malicious or harmful software), a file may resolve to a particular IP address, a file may modify the virtual computing devices operating system in some way, etc. FIG. 7 is a schematic diagram representing connections established based on behaviors shown in FIG. 6 that are shared with other files, according to certain aspects of the present disclosure.

As more files are added to the system, and/or more YARA rules, various connections and patterns may be identified permitting associations with malicious software to be identified far sooner than has been available prior to the present invention.

In some embodiments of the present disclosure, third party data sources may be added to enhance the information present in the now-created real-time threat knowledge graph. As such information is added, the graph may be re-evaluated to see if any new connections, patterns, files, etc. can be identified. FIG. 8 is a schematic diagram representing the expansion of connections based upon third party data, according to certain aspects of the present disclosure.

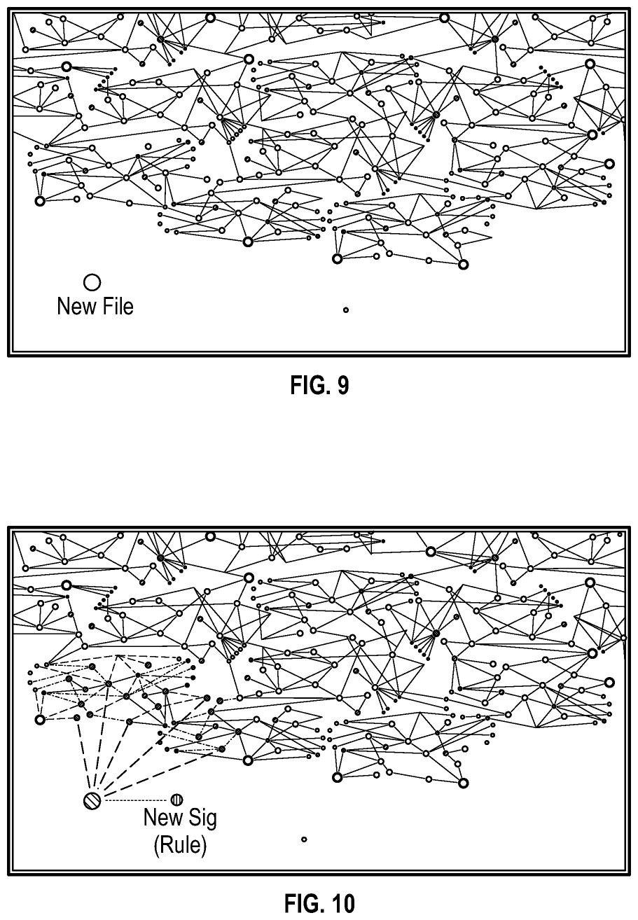

According to some aspects of the present disclosure, predictions may be made utilizing the real-time threat knowledge graph and potentially malicious files may be identified at an early enough stage so as to eliminate or reduce any damage caused by such files. A knowledge graph in accordance with certain aspects of the present disclosure may allow predictions to be made by analysis of the fabric of these connections. In this way, the real-time threat knowledge graph in accordance with embodiments of the present disclosure enables the Internet security industry to be proactive rather than reactive with respect to potential security threats. FIG. 9 is a schematic diagram representing the introduction of a new file to the real-time threat knowledge graph, according to certain aspects of the present disclosure.

FIG. 10 is a schematic diagram representing connections to the new file using the real-time threat knowledge graph that permit the new file of FIG. 9 to be identified as malicious, according to certain aspects of the present disclosure.

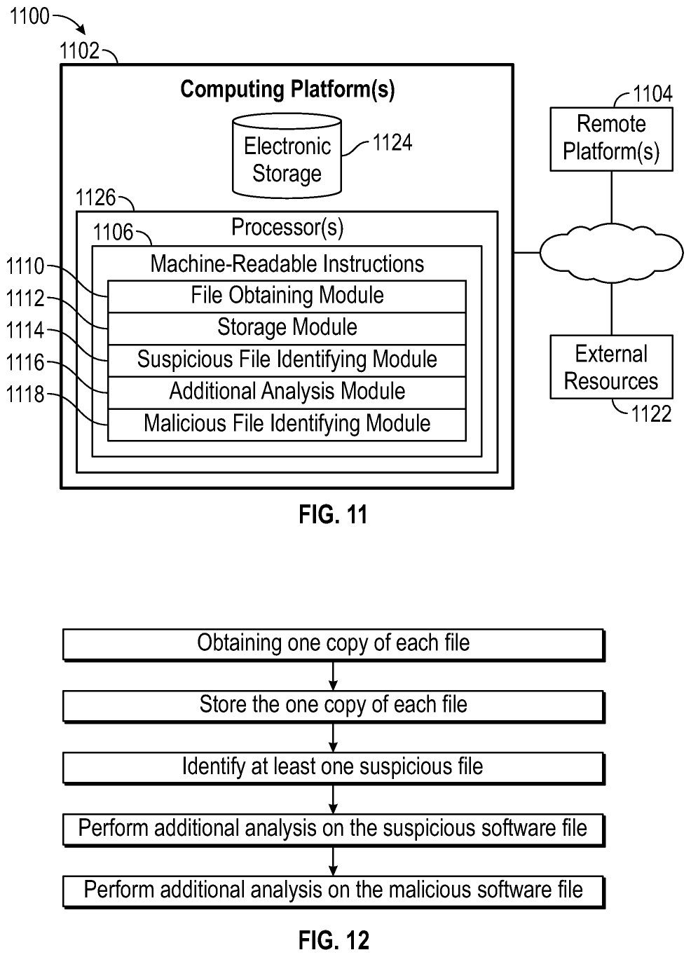

FIG. 11 illustrates a system 1100 configured for generating real-time threat knowledge graphs and using such graphs to identify malicious software files, according to certain aspects of the disclosure. In some implementations, system 1100 may include one or more computing platforms 1102. Computing platform(s) 1102 may be configured to communicate with one or more remote platforms 1104 according to a client/server architecture, a peer-to-peer architecture, and/or other architectures. Remote platform(s) 1104 may be configured to communicate with other remote platforms via computing platform(s) 1102 and/or according to a client/server architecture, a peer-to-peer architecture, and/or other architectures. Users may access system 1100 via remote platform(s) 1104.

Computing platform(s) 1102 may be configured by machine-readable instructions 1106. Machine-readable instructions 1106 may include one or more instruction modules. The instruction modules may include computer program modules. The instruction modules may include one or more of a file obtaining module 1110, a storage module 1112, a suspicious software file identifying module 1114, an additional analysis module 1116, a malicious software file identifying module 1118, and/or other instruction modules.

The file obtaining module 1110 may be configured to obtain a single copy of each file of a plurality of files that is present on one or more of a plurality of computing devices comprising a computing enterprise. That is, if there are 18 computing devices 100 comprising a computing enterprise 200 (as shown in FIG. 2), and each file contains executable file ABC.exe, only a single copy of ABC.exe is obtained, rather than 18. In aspects, the file obtaining module 1110 may be configured to obtain a single copy of each file of a plurality of files that is present on one or more of a plurality of computing devices comprising an organization. In aspects, the file obtaining module 1110 may be configured to obtain a single copy of each file of a plurality of files that is present on one or more of a plurality of computing devices comprising an industry of computing enterprises. In aspects, the file obtaining module 1110 may be configured to obtain a single copy of each file of a plurality of files that is present on one or more of a plurality of computing devices comprising all or substantially all of the computing enterprises across the globe. Any and all such variations, and any combination thereof, are contemplated to be within the scope of embodiments of the present disclosure.

Once a single copy of every file that is present on any of the computing devices 100 comprising the computing enterprise 200 (organization, industry, globe, etc.) is obtained, the file copies are backhauled into a storage system (e.g., a cloud-based data store). Thus, the storage module 1112 may be configured to store the single copy of each file of the plurality of files in a data store. In the event that a malicious software file had been introduced on one or more of the computing devices comprising a computing enterprise (organization, industry, globe, etc.), a copy of the malicious software file also will be backhauled into the storage system.

The suspicious software file identifying module 1114 may be configured to identify at least one suspicious file in the plurality of files stored in the data store. Identifying the suspicious software file(s) may be accomplished in a number of different ways. For instance, the suspicious software file(s) may be identified by heuristics. By way of example only, heuristics may be applied to the stored files to determine that a certain file, rather than being present on each computing device comprising a computing enterprise, is present on only a small percentage of the computing devices comprising the computing enterprise. For instance, in the computing enterprise 200 illustrated in FIG. 2, a certain file may be present on only 3 of the 18 computing devices comprising the computing enterprise 200. One-sixth of the computing devices may be a low enough percentage to be considered statistically “rare” or unexpected in certain embodiments. (It will be understood and appreciated by those having ordinary skill in the art that the threshold percentage at or under which a file is considered statistically “rare” or unexpected is configurable and may be any desired threshold. Embodiments of the present disclosure are not intended to be limited to any particular percentage, percentage range, or number.) In some embodiments, presence at or below a predetermined threshold percentage (or number) of computing devices may be supplemented with a determination of whether and/or how often the certain file has been identified on other computing devices associated with a customer or public data source. In such embodiments, files that have not previously been identified, or only rarely identified, may be identified a “not widely known” and may be treated with enhanced suspicion. In this way, potentially offending (e.g., suspicious) files may be identified without having to know in advance if they are malicious or not malicious and before such files, if malicious, are propagated to a larger percentage (or number) of computing devices comprising the computing enterprise.

Another method in which the suspicious software file identifying module 1114 may identify a suspicious software file may be through the use of YARA rules. YARA is an open-source computing language that provides a way of identifying malware (or other files) by creating rules that look for certain characteristics. Utilizing YARA, a user basically writes a sort of recipe or rule and evaluates suspicious files (or any files) against it to determine if the file matches the rule. Files matching rules then may be considered malicious (or at least suspicious). YARA is widely utilized to scan a directory of files on a single computing device but is not capable of scanning all the computing devices comprising a computing enterprise unless a rule is simply run against each individual computing device file directory. In accordance with certain embodiments of the present disclosure, however, since a single copy of each file present in association with any computing device comprising the computing enterprise has been backhauled to a storage system, a YARA rule may be applied to the storage system to identify potentially suspicious and/or malicious files. Applying YARA rules in this way significantly decreases the time, power and resources that would be required to apply the YARA rule against every computing device comprising a computing enterprise individually. Such application not only is more efficient in terms of throughput, but it also reduces the load on individual computing devices that can affect performance of the computing device while the rule is being applied.

In aspects, the suspicious software file identifying module 1114 may be configured to automatically generate YARA signatures. In such aspects, files may be input into the suspicious software file identifying module 1114 and the suspicious software file identifying module 1114 may output a set of features extracted or derived from (about) one or more of the input files. Randomly or intelligently, the suspicious software file identifying module 1114 may generate a plurality of different YARA signatures from the extracted features. In such aspects, rather than having one YARA signature that matches one malware sample or family, a large number of YARA signatures may be generated that each have a plurality of features (e.g., three or four features (of the set of extracted or derived features)) randomly shuffled together. The suspicious software file identifying module 1114 may determine that a plurality (e.g., three) of the large number of YARA signatures match a particular file. Such a match would be indicative of a significant likelihood that the particular file is a suspicious and/or malicious software file. Further, if it is noticed over time that a particular plurality of YARA signatures tends to match malicious software files and that, with respect to a specific file one fewer than the particular plurality of YARA signatures matches, such may be indicative of a particular malicious software file morphing or changing in some way, such file behavior being indicative of a file upon which further analysis may be desired.

The additional analysis module 1116 may be configured to perform additional analysis of the at least one suspicious file.

The malicious software file identifying module 1118 may be configured to identify the at least one suspicious file as a malicious software file based upon the additional analysis. In aspects, the malicious software file identifying module 1118 may be configured to provide the at least one suspicious file with a threat score indicative of how likely it is that the at least one suspicious file is a malicious software file rather than providing a malicious or non-malicious determination. Any and all such variations, and any combination thereof, are contemplated to be within the scope of embodiments of the present disclosure.

In some implementations, computing platform(s) 1102, remote platform(s) 1104, and/or external resources 1122 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1102, remote platform(s) 1104, and/or external resources 1122 may be operatively linked via some other communication media.

A given remote platform 1104 may include one or more processors configured to execute computer program modules. The computer program modules may be configured to enable an expert or user associated with the given remote platform 1104 to interface with system 1100 and/or external resources 1122, and/or provide other functionality attributed herein to remote platform(s) 1104. By way of non-limiting example, a given remote platform 1104 and/or a given computing platform 1102 may include one or more of a server, a desktop computer, a laptop computer, a handheld computer, a tablet computing platform, a NetBook, a Smartphone, a gaming console, and/or other computing platforms.

External resources 1122 may include sources of information outside of system 1100, external entities participating with system 1100, and/or other resources. In some implementations, some or all of the functionality attributed herein to external resources 1122 may be provided by resources included in system 1100.

Computing platform(s) 1102 may include electronic storage 1124, one or more processors 1126, and/or other components. Computing platform(s) 1102 may include communication lines, or ports to enable the exchange of information with a network and/or other computing platforms. Illustration of computing platform(s) 1102 in FIG. 11 is not intended to be limiting. Computing platform(s) 1102 may include a plurality of hardware, software, and/or firmware components operating together to provide the functionality attributed herein to computing platform(s) 1102. For example, computing platform(s) 1102 may be implemented by a cloud of computing platforms operating together as computing platform(s) 302.

Electronic storage 1124 may comprise non-transitory storage media that electronically stores information. The electronic storage media of electronic storage 1124 may include one or both of system storage that is provided integrally (i.e., substantially non-removable) with computing platform(s) 1102 and/or removable storage that is removably connectable to computing platform(s) 1102 via, for example, a port (e.g., a USB port, a firewire port, etc.) or a drive (e.g., a disk drive, etc.). Electronic storage 1124 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1124 may include one or more virtual storage resources (e.g., cloud storage, a virtual private network, and/or other virtual storage resources). Electronic storage 1124 may store software algorithms, information determined by processor(s) 1126, information received from computing platform(s) 1102, information received from remote platform(s) 1104, and/or other information that enables computing platform(s) 1102 to function as described herein.

Processor(s) 1126 may be configured to provide information processing capabilities in computing platform(s) 1102. As such, processor(s) 1126 may include one or more of a digital processor, an analog processor, a digital circuit designed to process information, an analog circuit designed to process information, a state machine, and/or other mechanisms for electronically processing information. Although processor(s) 1126 is shown in FIG. 11 as a single entity, this is for illustrative purposes only. In some implementations, processor(s) 1126 may include a plurality of processing units. These processing units may be physically located within the same device, or processor(s) 1126 may represent processing functionality of a plurality of devices operating in coordination. Processor(s) 1126 may be configured to execute modules 1110, 1112, 1114, 1116, and/or 1118, and/or other modules. Processor(s) 1126 may be configured to execute modules 1110, 1112, 1114, 1116, and/or 1118, and/or other modules by software; hardware; firmware; some combination of software, hardware, and/or firmware; and/or other mechanisms for configuring processing capabilities on processor(s) 1126. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1110, 1112, 1114, 1116, and/or 1118 are illustrated in FIG. 11 as being implemented within a single processing unit, in implementations in which processor(s) 1126 includes multiple processing units, one or more of modules 1110, 1112, 1114, 1116, and/or 1118 may be implemented remotely from the other modules. The description of the functionality provided by the different modules 1110, 1112, 1114, 1116, and/or 1118 described below is for illustrative purposes, and is not intended to be limiting, as any of modules 1110, 1112, 1114, 1116, and/or 1118 may provide more or less functionality than is described. For example, one or more of modules 1110, 1112, 1114, 1116, and/or 1118 may be eliminated, and some or all of its functionality may be provided by other ones of modules 1110, 1112, 1114, 1116, and/or 1118. As another example, processor(s) 1126 may be configured to execute one or more additional modules that may perform some or all of the functionality attributed below to one of modules 1110, 1112, 1114, 1116, and/or 1118.

The techniques described herein may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

FIG. 12 illustrates an example flow diagram (e.g., process 1200) for identifying malicious software files, according to certain aspects of the disclosure. For explanatory purposes, the example process 1200 is described herein with reference to FIGS. 1-10. Further for explanatory purposes, the steps of the example process 1200 are described herein as occurring in serial, or linearly. However, multiple instances of the example process 1200 may occur in parallel.

At step 1210, the process 1200 may include obtaining a single copy of each file of a plurality of files that is present on one or more of a plurality of computing devices comprising a computing enterprise (organization, industry, globe, etc.), e.g., utilizing the file copy obtaining module 1110 of the system 1100 of FIG. 11.

At step 1212, the process 1200 may include storing the single copy of each file of the plurality of files in a data store, e.g., utilizing the storage module 1112 of the system 1100 of FIG. 11.

At step 1214, the process 1200 may include identifying at least one suspicious file in the plurality of files stored in the data store, e.g., utilizing the suspicious file identifying module 1114 of the system 1100 of FIG. 11.

At step 1216, the process 1200 may include performing additional analysis on the suspicious software file, e.g., utilizing the additional analysis module 1116 of the system 1100 of FIG. 11.

At step 1218, the process 1200 may include identifying the at least one suspicious file as a malicious software file, e.g., utilizing the malicious file identifying module 1118 of the system 1100 of FIG. 11. In aspects, step 1218 may include providing a threat score indicative of how likely it is that the at least one suspicious file is a malicious software file.

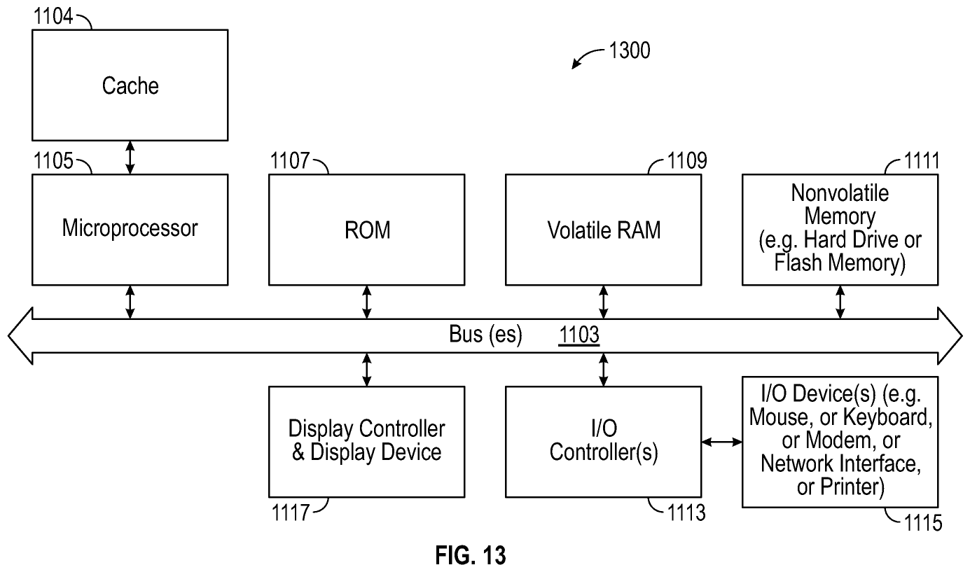

FIG. 13 is a block diagram illustrating an exemplary computer system 1300 with which aspects of the subject technology can be implemented. In certain aspects, the computer system 1300 may be implemented using hardware or a combination of software and hardware, either in a dedicated server, integrated into another entity, or distributed across multiple entities.

Computer system 1300 (e.g., server and/or client) includes a bus 1308 or other communication mechanism for communicating information, and a processor 1302 coupled with bus 1308 for processing information. By way of example, the computer system 1300 may be implemented with one or more processors 1302. Processor 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 1300 can include, in addition to hardware, code that creates an execution environment for the computer program in question, e.g., code that constitutes processor firmware, a protocol stack, a database management system, an operating system, or a combination of one or more of them stored in an included memory 1304, such as a Random Access Memory (RAM), a flash memory, a Read Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. The processor 1302 and the memory 1304 can be supplemented by, or incorporated in, special purpose logic circuitry.

The instructions may be stored in the memory 1304 and implemented in one or more computer program products, i.e., one or more modules of computer program instructions encoded on a computer readable medium for execution by, or to control the operation of, the computer system 1300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1304 may also be used for storing temporary variable or other intermediate information during execution of instructions to be executed by processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 1300 further includes a data storage device 1306 such as a magnetic disk or optical disk, coupled to bus 1308 for storing information and instructions. Computer system 1300 may be coupled via input/output module 1310 to various devices. The input/output module 1310 can be any input/output module. Exemplary input/output modules 1310 include data ports such as USB ports. The input/output module 1310 is configured to connect to a communications module 1312. Exemplary communications modules 1312 include networking interface cards, such as Ethernet cards and modems. In certain aspects, the input/output module 1310 is configured to connect to a plurality of devices, such as an input device 1314 and/or an output device 1316. Exemplary input devices 1314 include a keyboard and a pointing device, e.g., a mouse or a trackball, by which a user can provide input to the computer system 1300. Other kinds of input devices 1314 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1316 include display devices such as an LCD (liquid crystal display) monitor, for displaying information to the user.

According to one aspect of the present disclosure, the above-described gaming systems can be implemented using a computer system 1300 in response to processor 1302 executing one or more sequences of one or more instructions contained in memory 1304. Such instructions may be read into memory 1304 from another machine-readable medium, such as data storage device 1306. Execution of the sequences of instructions contained in the main memory 1304 causes processor 1302 to perform the process steps described herein. One or more processors in a multi-processing arrangement may also be employed to execute the sequences of instructions contained in memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 1300 can include clients and servers. A client and server are generally remote from each other and typically interact through a communication network. The relationship of client and server arises by virtue of computer programs running on the respective computers and having a client-server relationship to each other. Computer system 1300 can be, for example, and without limitation, a desktop computer, laptop computer, or tablet computer. Computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer readable medium” as used herein refers to any medium or media that participates in providing instructions to processor 1302 for execution. Such a medium may take many forms, including, but not limited to, non-volatile media, volatile media, and transmission media. Non-volatile media include, for example, optical or magnetic disks, such as data storage device 1306. Volatile media include dynamic memory, such as memory 1304. Transmission media include coaxial cables, copper wire, and fiber optics, including the wires that comprise bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include”, “have”, or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration”. Any embodiment described herein as “exemplary” is not necessarily to be construed as preferred or advantageous over other embodiments.

A reference to an element in the singular is not intended to mean “one and only one” unless specifically stated, but rather “one or more”. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for identifying malicious software files, the method comprising:
obtaining a single copy of each file of a plurality of files that is present on one or more of a plurality of computing devices comprising a computing enterprise;
storing the single copy of each file of the plurality of files in a data store;
identifying at least one suspicious file in the plurality of files stored in the data store;
performing additional analysis of the at least one suspicious file; and
identifying the at least one suspicious file as a malicious software file based upon the additional analysis.

2. The computer-implemented method of claim 1, wherein each of the plurality of computing devices comprising the computing enterprise includes substantially the same plurality of files.

3. The computer-implemented method of claim 1, wherein storing the single copy of each file of the plurality of files in the data store comprises backhauling the single copy of each file of the plurality of files.

4. The computer-implemented method of claim 1, wherein identifying the at least one suspicious file in the plurality of files stored in the data store comprises identifying at least one file that is statistically rare.

5. The computer-implemented method of claim 4, wherein the at least one file that is statistically rare is present on less than n% of the plurality of computing devices comprising the computing enterprise.

6. The computer-implemented method of claim 5, wherein the at least one file that is present on less than n% of the plurality of computing devices comprising the computing enterprise is not widely known in public data sources.

7. The computer-implemented method of claim 1, wherein identifying the at least one suspicious file in the plurality of files stored in the data store comprises determining that the at least one suspicious file contains a character string that matches a YARA rule.

8. The computer-implemented method of claim 1, wherein performing additional analysis of the at least one suspicious file comprises identifying at least one of a connection of the at least one suspicious file to a known malicious software file, and a pattern displayed by the at least one suspicious file that is a pattern displayed by at least one software file known to be malicious.

9. A system configured for identifying malicious software files, the system comprising:
one or more hardware processors configured by machine-readable instructions to:
obtain a single copy of each file of a plurality of files that is present on one or more of a plurality of computing devices comprising a computing enterprise;
store the single copy of each file of the plurality of files in a data store;
identify at least one file-of-interest in the plurality of files stored in the data store;
perform additional analysis of the at least one file-of-interest; and
identify the at least one file-of-interest as a malicious software file based upon the additional analysis.

10. The system of claim 9, wherein each of the plurality of computing devices comprising the computing enterprise includes substantially the same plurality of files.

11. The system of claim 9, wherein the one or more hardware processors are configured by the machine-readable instructions to backhaul the single copy of each file of the plurality of files.

12. The system of claim 9, wherein the one or more hardware processors are configured by the machine-readable instructions to identify at least one file that is statistically rare.

13. The system of claim 12, wherein the one or more hardware processors are configured by the machine-readable instructions to determine that the at least one file that is statistically rare is present on less than n% of the plurality of computing devices comprising the computing enterprise.

14. The system of claim 13, wherein the at least one file that is present on less than n% of the plurality of computing devices comprising the computing enterprise is not widely known in public data sources.

15. The system of claim 9, wherein identifying the at least one file-of-interest in the plurality of files stored in the data store comprises determining that the at least one file-of-interest contains a character string that matches a YARA rule.

16. The system of claim 11, wherein the one or more hardware processors are configured by the machine-readable instructions to at least one of identify at least one of a connection of the at least one file-of-interest to a known malicious software file, and a pattern displayed by the at least one file-of-interest that is a pattern displayed by software files known to be malicious.

17. A non-transient computer-readable storage medium having instructions embodied thereon, the instructions being executable by one or more processors to perform a method for identifying malicious software files, the method comprising:
obtaining a single copy of each file of a plurality of files that is present on one or more of a plurality of computing devices comprising a computing enterprise;
storing the single copy of each file of the plurality of files in a data store;
identifying at least one suspicious file in the plurality of files stored in the data store;
performing additional analysis of the at least one suspicious file; and
identifying the at least one suspicious file as a malicious software file based upon the additional analysis.

18. The non-transient computer-readable storage media of claim 17, wherein the instructions embodied thereon are further executable by the one or more processors to identify the at least one suspicious file in the plurality of files stored in the data store comprises identifying at least one file that is statistically rare.

19. The non-transient computer-readable storage media of claim 17, wherein the instructions embodied thereon are further executable by the one or more processors to determine that the at least one suspicious file contains a character string that matches a YARA rule.

20. The non-transient computer-readable storage media of claim 17, wherein the instructions embodied thereon are further executable by the one or more processors to identify at least one of a connection of the at least one suspicious file to a known malicious software file, and a pattern displayed by the at least one suspicious file that is a pattern displayed by software files known to be malicious.
